(19) United States
(12) Patent Application Publication
(10) Pub. No.: US 2007/0110346 A1
(43) Pub. Date: May 17, 2007

(54) Linear slide assembly method and apparatus

(76) Inventor: Henry L. Gibbs, Millis, MA (US)

Correspondence Address: JOHN E. TOUPAL, 116 CONCORD STREET, FRAMINGHAM, MA, 01701, US

(21) Appl. No.: 10/554,606

(22) PCT Filed: Jul. 16, 2004
(86) PCT No.: PCT/US04/22925

§ 371 Date: Oct. 26, 2005

(51) Int. Cl. F16C 29/04

(52) U.S. Cl. 384/49

(57) ABSTRACT

A linear slide apparatus including a bifurcated base member (13) having spaced apart first (16) and second (17) upright portions; a slide member (12) spaced from the base member (13) and disposed between the first and second upright portions; a first raceway (21) formed between the slide member and the first upright portion; and a second raceway (22) formed between the slide member and the second upright portion and extending parallel to the first raceway with the raceways having substantially square cross sections and open tops (10). Also included are a support assembly (14, 15) retained by each raceway and arranged to support the slide member on the base member with each support assembly having four elongated rods (37, 38, 41, 42) each disposed in a different corner of the retaining raceway, a plurality of balls (36) engaged between the four elongated rods and a carriage member (44) maintaining separation between the balls. Removable base and slide top covers (54, 56, and 52) partially cover the open tops of the raceways.

This application claims priority from International Patent Application No. PCT/US04/22925, international filing date 16 Jul. 2004, entitled LINEAR SLIDE ASSEMBLY METHOD AND APPARATUS.

### BACKGROUND OF THE INVENTION

This invention relates generally to linear slides, and more particularly to low friction slides.

Low friction linear slides generally include a bifurcated member straddling another. Either member can be fixed and the other slides with respect to it on two linear bearings sandwiched between the bifurcations of the one member and the sides of the straddled member. According to one known low friction linear slide structure, four longitudinally extending rods form a raceway with two of the rods retained by each member. Carried by the rods are either ball bearings or cylindrical bearings that roll along the rods during relative movement between the slide members. Various types of such linear slide devices include those with cylindrical rods and ball bearings, flattened rods and crossed roller bearings and grooved rods and ball bearings.

Previous ball slides typically use set screws pressing on a gib to provide optimum adjustment. The gib pushes on both rods constrained in a channel. By design, the centers of the two rod diameters do not change in the vertical direction as both rods can move and provide adjustment in the horizontal direction pressing on the bearing balls contained between the rods in the base of the slide and the top of the slide. Examples of those types of slide devices are disclosed in U.S. Pat. Nos. 2,672,378; 3,113,807; 3,790,233; 3,897,119; 4,696,586; 4,797,008; 4,923,311; and 5,672,010. During assembly of previous ball slides, bearing members typically consisting of rods, balls and ball retainers, are slid into ends of raceways formed between base and slide members of the device. In some ball slide devices a gib and compliant elastomer strip are inserted into an end of one raceway and then engaged by an adjusting screw to provide a preload on the bearing members. These procedures rendered assembly of the ball slides quite difficult.

The object of this invention is to provide an improved linear slide mechanism that exhibits extreme smoothness and ease of assembly.

### SUMMARY OF THE INVENTION

The invention is a linear slide apparatus including a bifurcated base member having spaced apart first and second upright portions; a slide member spaced from the base member and disposed between the first and second upright portions; a first raceway formed between the slide member and the first upright portion; and a second raceway formed between the slide member and the second upright portion and extending parallel to the first raceway with the raceways having substantially square cross sections and open tops. Also included are a support assembly retained by each raceway and arranged to support the slide member on the base member with each support assembly having four elongated rods each disposed in a different corner of the retaining raceway, a plurality of balls engaged between the four elongated rods and a carriage member maintaining separation between the balls. A first base top cover is secured to the first upright portion, partially covering the open top of the first raceway, and engaging the rod disposed in an upper outer corner thereof, a second base top cover secured to the second upright portion, partially covering the open top of the second raceway, and engaging the rod disposed in an upper outer corner of the second raceway; and a slide top cover is secured to the slide member, partially covering the open tops of the raceways and engaging the rods disposed in upper inner corners thereof. The support members can be inserted through the open tops of the raceways to simplify assembly of the slide device.

According to certain features of the invention, the first and second base top covers are secured to the upright portions by a plurality of removable fasteners, and the slide top cover is a unitary plate secured to the slide member by a plurality of removable fasteners. These features further simplify assembly and adjustment.

According to other features of the invention, the raceways have at least one open end and the device includes a base end cover secured to the base member and partially covering the open ends thereof, and a slide end cover secured to the slide member and partially covering the open ends of the raceways. Further assembly simplification is provided by these features.

According to yet other features, the raceways include one longitudinal bottom corner formed by perpendicularly intersecting surfaces of, respectively, the first and second upright portions, and another longitudinal bottom corner formed by perpendicularly intersecting surfaces of the slide member, and each pair of the intersecting surfaces retains one of the rods. These features provide accurate alignment of the support bearing components.

### DESCRIPTION OF THE DRAWINGS

These and other objects and features of the invention will become more apparent upon a perusal of the following description taken in conjunction with the accompanying drawings wherein:

FIG. 1 is a front perspective view of a linear slide according to the invention;

FIG. 2 is a cross sectional view taken along lines 2-2 of FIG. 1;

FIG. 3 is a perspective view illustrating relative movement between slide and base members of the device shown in FIGS. 1-2;

FIG. 4 is a detailed view illustrating one step in the assembly of the device shown in FIGS. 1-3; and

FIG. 5 is a detailed view illustrating another step in the assembly of the device shown in FIGS. 1-3.

### DESCRIPTION OF THE PREFERRED EMBODIMENT

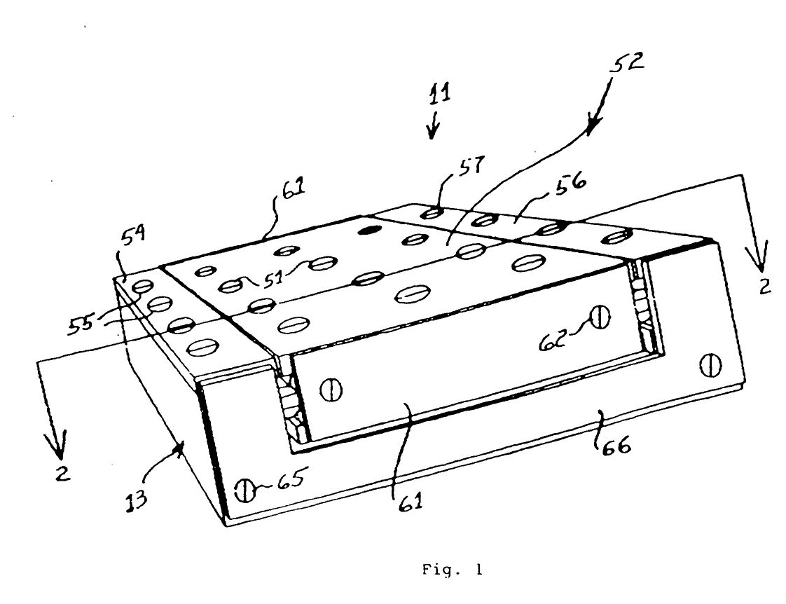

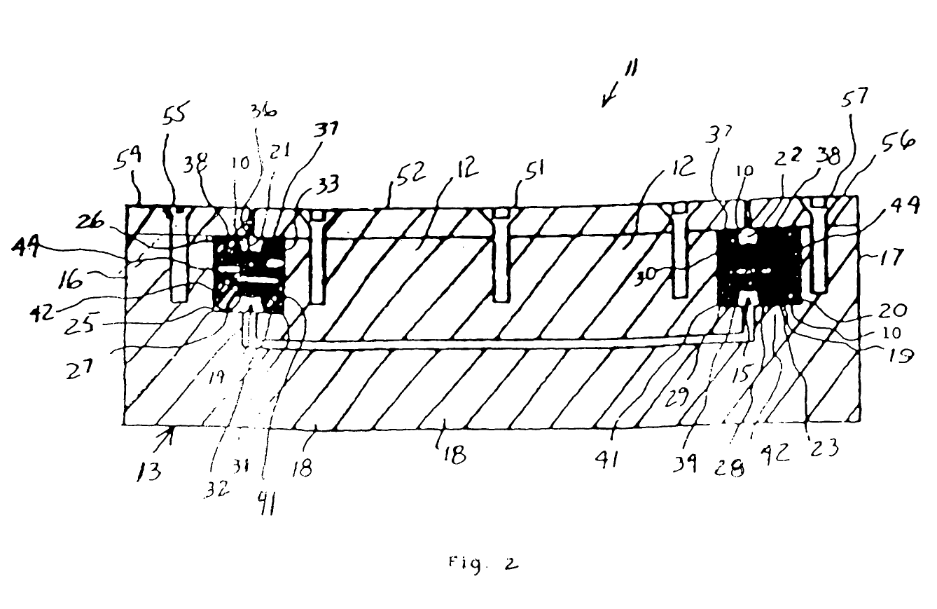

A linear slide 11 includes a slide member 12 supported on a base member 13 by a pair of elongated support assemblies 14, 15 as shown in FIGS. 1 and 2. The base member 13 is bifurcated with a pair of spaced apart first and second upright portions 16, 17 projecting upwardly from a base portion 18. Disposed between the first and second upright portions 16, 17 and maintained spaced apart therefrom by the first and second support assemblies 14, 15 is the slide member 12.

Retaining the first and second support assemblies 14, 15 are, respectively, first and second parallel elongated raceways 21, 22. The raceways 21, 22 are identical as shown in FIG. 2, with each having a square cross-section and an open top 10. Side and bottom surfaces of the raceway 21 are formed by the upright portion 16, and the slide member 12 while the raceway 22 is formed by the upright portion 17, the slide member 12 and a gib 19 separated from the upright portion 17 by a shim 24 and a resilient elastomer strip 20 as shown in FIG. 2. The raceway 21 has a longitudinally extending bottom outer corner 25 formed by perpendicularly intersecting surfaces 26, 27 of the upright portion 16, and an inner bottom corner 31 formed by perpendicularly intersecting surfaces 32, 33 of the slide member 12. Similarly, the raceway 22 has a longitudinally extending bottom outer corner 23 formed by the intersection of the gib 20 and a surface 28 of the upright portion 17, and a longitudinally extending inner bottom corner 29 formed by perpendicularly intersecting surfaces 30, 34 of the slide member 12.

The first and second support assemblies 14, 15 also are identical and each includes a plurality of longitudinally distributed balls 36 engaged between inner and outer longitudinally extending upper cylindrical rods 37, 38 disposed in upper corners of the raceways 21, 22 and longitudinally extending lower cylindrical rods 41, 42 disposed in, respectively, the inner and outer bottom corners 31, 25 of the raceway 21 and the inner and outer bottom corners 29, 23 of the raceway 22. Separation between the balls 36 is maintained by apertured carriage members 44.

Secured to an upper surface of the slide member 12 by machine screw fasteners 51 is a slide top cover 52 as shown in FIGS. 1 and 2. The slide top cover 52 covers the entire upper surface of the slide member 12 and extends laterally therefrom to partially cover the open tops 10 of the raceways 21, 22 and engage upper surfaces of the upper inner rods 37. A first base top cover 54 is secured by machine screw fasteners 55 to the upper surface of the first upright portion 16 and extends laterally over the first raceway 21 to partially cover its open top 10 and engage the upper outer rod 38. Similarly, a second base top cover 56 is secured by fasteners 57 to an upper surface of the second upright portion 17 and extends laterally over the second raceway 22 to partially cover its open top 10 and engage the upper outer rod 38.

A slide end cover 61 is secured to each end surface of the slide member 25 by machine screw fasteners 62 as shown in FIG. 1. The end covers 61 extend laterally over the raceways 21, 22 to partially cover the open ends thereof and engage the outer ends of, respectively, the upper inner and lower inner rods 37, 41. Similarly secured to end surfaces of the base member 13 by machine screw fasteners 65 are base end covers 66. The base end covers 66 project laterally from the upright portions 16, 17 and over the raceways 21, 22 to partially cover the open ends 10 thereof, and engage ends of, respectively, the upper outer and lower outer rods 38, 42.

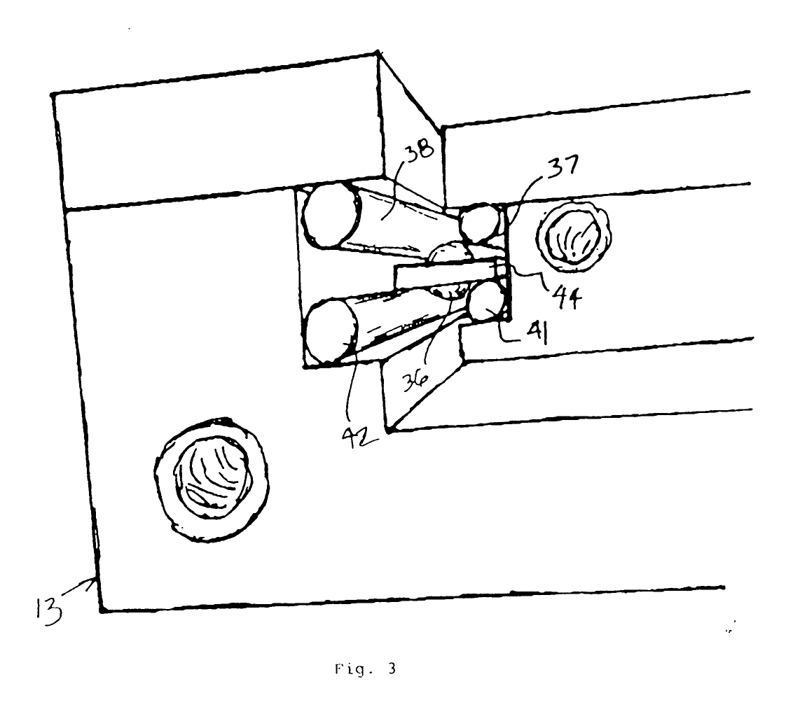

During use of the bearing slide 11, the slide member 12 moves rectilinearly relative to the base member 13 in a direction defined by the raceways 21, 22 as shown in FIG. 3. Such movement is facilitated by rolling movement of balls 36 on the rods 37, 38, 41 and 42 of the support assemblies 14, 15. The accurate alignment of the rods as described below results in highly smooth operation.

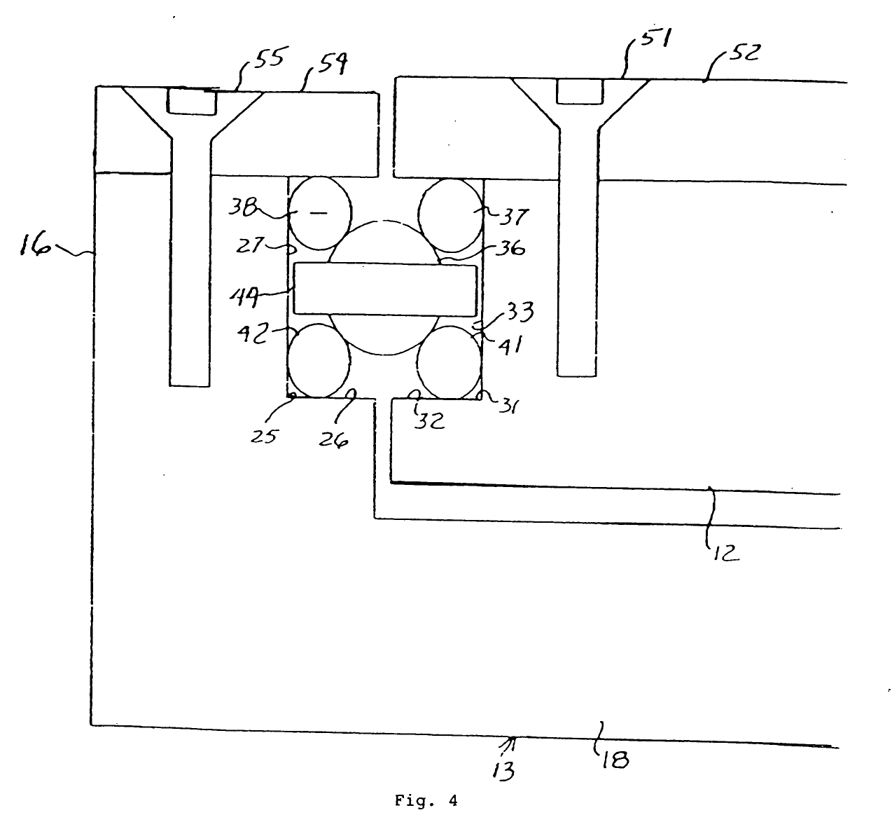

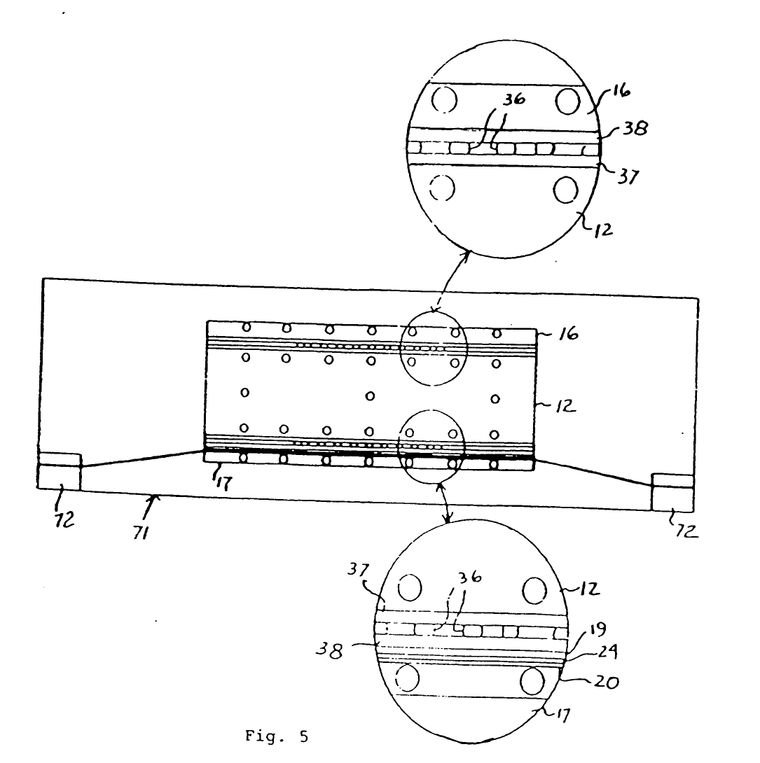

During assembly of the linear slide 11, the slide member 12 is positioned between the first and second upright portions 16, 17 of the base member 13 mounted on a fixture 71 (FIG. 5). The gib 19 elastomer strip 20 and shim 24 then are positioned in the raceway 22 with ends of the strip 20 secured to clamp blocks 72 to maintain the strip tension and thereby reduce the size of its normal cross section. Next, the assemblies 14, 15 with their carriage 44, ball 36 and rods 37, 38, 41 and components previously assembled in suitable fixtures (not shown) are inserted into the raceways 21, 22 through the open tops 24. After insertion of the assemblies 14, 15 into the raceways 21, 22, the ends of the elastomer strip 20 are released from the blocks 72 allowing the strip to contract and provide a lateral preload on the balls 36. The slide and base end covers 61, 66 then are attached with the screws 62, 65 to partially cover the open ends of the raceways 21, 22. Finally, after the slide top cover 52 and the base top cover 56 have been secured, respectively, to the slide member 12 and the base member 13, the remaining base top cover 54 is secured to the upper surface of the upright portion 16 as shown in FIG. 4. As the base top cover 54 is tightened with the fasteners 55 it engages the upper surface of the upper outer rod 38 forcing it downwardly and exerting a compression force on the ball 36 directed at approximately 45 degrees to the ball's center. The compression force is transmitted to all other balls and rods of both support assemblies 14, 15. Further adjustment can be obtained by selective tightening of the slide top cover 52 and second base top covers 56 to adjust the positions of the upper rods 37, 38 and thereby establish precise alignment of the support assemblies 14, 15 within, respectively, the raceways 21, 22.

Obviously, many modifications and variations of the present invention are possible in light of the above teaching. It is to be understood, therefore, that the invention can be practiced otherwise than as specifically described.

1. A linear slide apparatus comprising:
a bifircated base member having spaced apart first and second upright portions;
a slide member spaced from said base member and disposed between said first and second upright portions;
a first raceway formed between said slide member and said first upright portion;
a second raceway formed between said slide member and said second upright portion and extending parallel to said first raceway, said first and second raceways having substantially square cross sections and open tops;
a support assembly retained by each of said first and second raceways and arranged to support said slide member on said base member; each said support assembly comprising four elongated rods each disposed in a different comer of said retaining raceway, a plurality of balls engaged between said four elongated rods and a carriage member maintaining separation between said balls;
a first base top cover secured to said first upright portion, partially covering said open top of said first raceway;
a second base top cover secured to said second upright portion, partially covering said open top of said second raceway, and engaging said rod disposed in an upper outer comer of said second raceway; and
slide top cover means secured to said slide member, partially covering said open tops of said first raceway and said second raceway.

2. A linear slide apparatus according to claim I wherein said first base top cover engages said rod disposed in an upper outer comer of said first raceway and said second base top cover engages a rod disposed in an upper outer corner of said second raceway.

3. A linear slide apparatus according to claim 2 wherein said slide top cover means engages said rods disposed in upper inner comers of each of said first and second raceways.

4. A liner slide apparatus according to claim 3 wherein said slide top cover means is a unitary plate.

5. A linear slide apparatus according to claim 1 wherein each of said first and second raceways has at least one open end and including base end cover means secured to said base member and partially covering said open ends thereof, and slide end cover means secured to said slide member and partially covering said one open end of each of said first and second raceways.

6. A linear slide apparatus according to claim 5 wherein said first base top cover engages said rod disposed in an upper outer comer of said first raceway and said second base top cover engages a rod disposed in an upper outer comer of said second raceway.

7. A linear slide apparatus according to claim 6 wherein said slide top cover means engages said rods disposed in upper inner comers of each of said first and second raceways.

8. A lear slide apparatus according to claim 7 wherein each of said slide top and end covers is a unitary plate.

9. A linear slide apparatus according to claim 5 wherein each of said first and second raceways comprises one longitudinal bottom comer formed by perpendicularly intersecting surfaces of, respectively, said first and second upright portions, and another longitudinal bottom comer formed by perpendicularly intersecting surfaces of said slide member, and each pair of said intersecting surfaces retain one of said rods.

10. A linear slide apparatus according to claim 9 wherein said first base top cover engages said rod disposed in an upper outer comer of said first raceway and said second base top cover engages a rod disposed in an upper outer corner of said second raceway.

11. A linear slide apparatus according to claim 10 wherein said slide top cover engages said rods disposed in upper inner corners of each of said first and second raceways.

12. A linear slide apparatus according to claim 11 wherein said slide top cover means is a unitary plate.

13. A linear slide apparatus according to claim I wherein each of said first and second raceways comprises one longitudinal bottom corner formed by perpendicularly intersecting surfaces of, respectively, said fit and second upright portions, and another longitudinal bottom comer-formed by perpendicularly intersecting surfaces of said slide member, and each pair of said intersecting surfaces retain one of said rods.

14. A linear slide apparatus according to claim 13 wherein said first base top cover engages said rod disposed in an upper outer corner of said first raceway and said second base top cover engages a rod disposed in an upper outer corner of said second raceway.

15. A linear slide apparatus according to claim 14 wherein said slide top cover means engages said rods disposed in upper inner comers of each of said first and second raceways.

16. A linear slide apparatus according to claim 15 wherein said slide top cover means is a unitary plate.

17. A linear slide apparatus according to claim 5 wherein an end of each of said first and second raceways opposite to said one end is open and partially covered by additional base and slide cover means.

18. A linear slide apparatus according to claim 1 further comprising a gib and an adjacent resilient strip disposed between one of said support assemblies and one of said first and second upright portions.

19. A method of assembling a linear slide device having a bifurcated base member with spaced apart first and second upright portions; a slide member spaced from the base member and disposed between the first and second upright portions; a first raceway formed between the slide member and the first upright portion;
a second raceway formed between the slide member and the second upright portion and extending parallel to the first raceway, the first and second raceways having substantially square cross sections and open tops; a support assembly retained by each of the first and second raceways and arranged to support the slide member on the base member; each support assembly comprising four elongated rods each disposed in a different comer of the retaining raceway, a plurality of balls engaged between the four elongated rods and a carriage member maintaining separation between the balls; a first base top cover secured to the first upright portion, partially covering the open top of the first raceway,
a second base top cover secured to the second upright portion, partially covering the open top of the second raceway, a slide top cover means secured to the slide member, partially covering the open tops of the first and second raceways, and a gib and adjacent resilient strip disposed between one of the support assemblies and one of the first and second upright portions, said method comprising the steps of:
positioning the slide member between the first and second upright members;
inserting a support assembly into each of the first and second raceways;
inserting a resilient strip in a longitudinal space between the base member and one of the support assemblies;
applying tension to stretch the resilient strip within the space;
inserting a gib between the stretched resilient strip and the one support assembly;
releasing the tension on the resilient strip to cause expansion thereof and preloading of the support assemblies; and
securing the first top cover to the first upright portion, the second top cover to the second upright portion, and the slide cover to the slide member.

20. A method according to claim 19 wherein each of the first and second raceways has at least one open end and including base end cover means secured to the base member and partially covering the open ends thereof and slide end cover means secured to the slide member and partially covering the at least one open end of each of the first and second raceways; and the method comprises the further steps of securing the base end cover means to the base member and the slide end cover means to the slide member.
